(19) United States
(12) Patent Application Publication
(10) Pub. No.: US 2013/0018800 A1
(43) Pub. Date: Jan. 17, 2013

(54) Secure Authorization of a Financial Transaction

(71) Applicant: Rangaraju Devaraju, Los Angeles, CA (US)

(72) Inventor: Rangaraju Devaraju, Los Angeles, CA (US)

(21) Appl. No.: 13/548,969

(22) Filed: Jul. 13, 2012

Related U.S. Application Data
(60) Provisional application No. 61/508,280, filed on Jul. 15, 2011.

(51) Int. Cl. G06Q 20/38

(52) U.S. Cl. 705/75

(57) ABSTRACT

Embodiments herein include a method implemented by a client device used by a consumer to securely conduct a financial transaction. The method includes generating a unique message digest by applying a cryptographic hash function to payment information uniquely associated with the consumer. The method also entails encrypting the unique message digest using a public key of a public-private key pair uniquely issued to the consumer, to obtain an encrypted digest. Finally, the method includes encrypting the encrypted digest and an index value using a symmetric key, to generate a card number to be sent to an authorization server for authorization of the financial transaction. This index value maps at the authorization server to the private key of the public-private key pair and to the payment information.

### RELATED APPLICATIONS

This application claims priority under 35 U.S.C. §119(e) to U.S. Provisional Patent Application Ser. No. 61/508,280, which was filed on Jul. 15, 2011, the entire disclosure of which is incorporated herein by reference.

### TECHNICAL FIELD

The present invention relates generally to authorization of a financial transaction, and in particular to securing payment information submitted by a consumer during that authorization process.

### BACKGROUND

In a substantial percentage of modern financial transactions, a consumer no longer pays for a merchant's goods or services with physical currency. Instead, the consumer provides the merchant with electronic payment information (e.g., a financial account number, the consumer's name, etc.). The merchant then sends this electronic payment information to a party that authorizes the financial transaction if the information is authentic. Often, the authorizing party returns an approval code to the merchant as evidence that the transaction was authorized.

This conventional authorization process relies on transport layer security (e.g., Secure Sockets Layer, SSL) to secure the electronic payment information sent to the authorizing party. Such lower-layer security measures, however, prove vulnerable to breach under some circumstances. When the measures are breached, the electronic payment information is immediately revealed and susceptible to abuse.

Some known approaches that address this problem merely limit the duration and extent to which the electronic payment information is valid. The information still remains vulnerable to being revealed.

### SUMMARY

Teachings herein secure electronic payment information so that it is not revealed during authorization of a financial transaction, even if lower-layer security measures, such as those providing transport layer security, are breached. The teachings irreversibly secure the electronic payment information within a card number and then send this card number, not the information itself, to an authorization server. This way, even if lower-layer security measures are breached and the card number revealed, the payment information itself is never revealed.

More particularly, embodiments herein include a method implemented by a client device used by a consumer to securely conduct a financial transaction. The method includes generating a unique message digest by applying a cryptographic hash function to payment information uniquely associated with the consumer. This payment information may include, for instance, the name of the consumer, all or part of an identification number for the consumer, or a financial account number of the consumer. Regardless, the method also entails encrypting the unique message digest using a public key of a public-private key pair uniquely issued to the consumer, to obtain an encrypted digest. Finally, the method includes encrypting the encrypted digest and an index value using a symmetric key, to generate a card number to be sent to an authorization server for authorization of the financial transaction. This index value maps at the authorization server to the private key of the public-private key pair and to the payment information.

Embodiments herein also include a corresponding method implemented by the authorization server for secure authorization of the financial transaction. Such method includes receiving a card number and decrypting that card number using a symmetric key to obtain an encrypted digest and an index value. The method further entails mapping the index value to a private key of a public-private key pair uniquely issued to a consumer and to payment information uniquely associated with that consumer. The method also includes decrypting the encrypted digest using this private key, to obtain a decrypted digest, and generating a unique message digest by applying a cryptographic hash function to the payment information. Finally, the method entails authorizing the financial transaction if the unique message digest generated by the authorization server matches the decrypted digest.

In at least some embodiments, the client device ties card number generation to the current time for added security. In one embodiment, for example, the client device generates the card number by encrypting the encrypted digest, the index value, and a timestamp associated with the time at which the card number is generated, using the symmetric key. The authorization server correspondingly decrypting the card number to obtain the encrypted digest, an index value, and a timestamp. The authorization server authorizes the financial transaction if the timestamp indicates the financial transaction has occurred within a predetermined time interval, but otherwise rejects the transaction.

In one or more embodiments, the client device obtains the card number by prepending one or more numbers to an encrypted block of bytes. In one embodiment, for instance, the client device encrypts the encrypted digest and the index value using the symmetric key, to obtain an encrypted block having multiple bytes. The client device then prepends one or more predetermined first numbers to each byte of the encrypted block that has a value represented with less than a predetermined number of digits, to obtain a modified encrypted block with each byte represented by the same number of digits. Finally, the client device prepends either a predetermined second number or a predetermined third number to each byte of the modified encrypted block, depending on a sign of that byte, to obtain the card number. The authorization server applies the reverse process to obtain the encrypted block from the received card number.

Of course, the present invention is not limited to the above features and advantages. Indeed, those skilled in the art will recognize additional features and advantages upon reading the following detailed description, and upon viewing the accompanying drawings.

### BRIEF DESCRIPTION OF DRAWINGS

FIG. 1 is block diagram of a payment system that includes a client device and an authorization server according to one or more embodiments.

FIG. 2 is a block diagram of a client device according to one or more embodiments.

FIG. 3 is a block diagram of an authorization server according to one or more embodiments.

FIG. 4 is a block diagram of a client device according to one or more Java Card embodiments.

FIG. 5 is a logic flow diagram of a method implemented by a client device according to one or more embodiments.

FIG. 6 is a logic flow diagram of a method implemented by an authorization server according to one or more embodiments.

FIG. 7 is a logic flow diagram of a method implemented by an authorization server according to one or more other embodiments.

### DETAILED DESCRIPTION

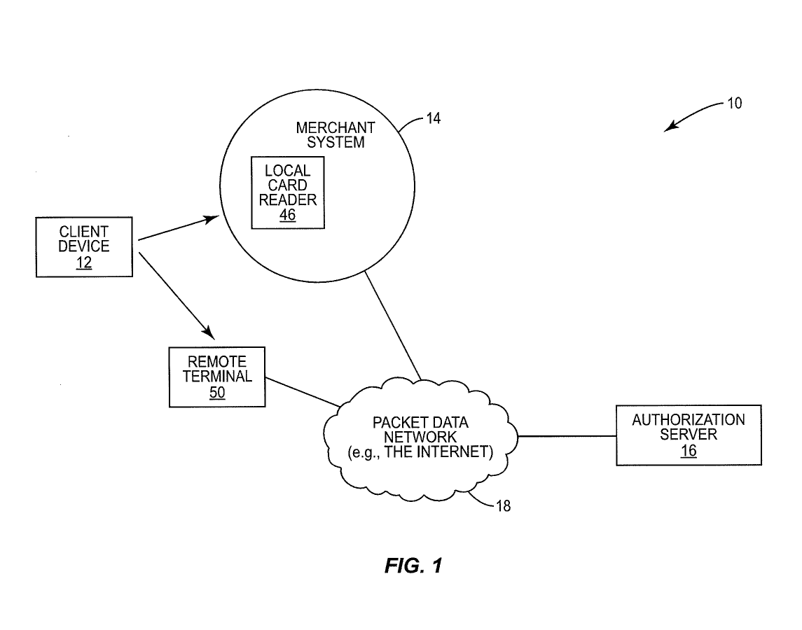

FIG. 1 illustrates an electronic payment system 10 for securely conducting a financial transaction between a consumer and a merchant. The system 10 includes a client device 12 used by the consumer, a merchant system 14 used by the merchant, and an authorization server 16 that authorizes the financial transaction.

The client device 12 includes a standalone digital card, such as a smart card, that effectively conveys electronic payment information to the merchant system 14 and authorization server 16 via a packet data network 18 (e.g., the Internet). This payment information is uniquely associated with the consumer and may include, for instance, the name of the consumer, a widely recognized identification number for the consumer (e.g., all or part of the consumer's Social Security Number), and/or a financial account number recognized by the authorization server 16. Upon authenticating the validity of this information, the authorization server 16 authorizes the financial transaction and may return an approval code to the merchant system 14 as evidence of that authorization. The authorization server 16 then causes the consumer's financial account to be charged with the purchase.

In some embodiments, the payment information is conveyed over the packet data network 18 using cryptographic protocols that provide transport layer security. Such protocols may include, for instance, Secure Sockets Layer (SSL). Such lower-layer security measures, however, prove vulnerable to breach under some circumstances.

Notably, the client device 12 ensures that the payment information remains secure from theft even if these lower-layer security measures are breached. In this regard, the client device 12 irreversibly secures the payment information within a card number. At least on its face, the card number in some embodiments is similar to a conventional credit or debit card number, including any card security code, meaning that the card number may be 16 digits without a card security code or 19 digits with a card security code. Regardless, this card number, not the information itself, is sent to the authorization server 16 over the packet data network 18. This way, even if lower-layer security measures are breached and the card number revealed, the payment information itself is never revealed.

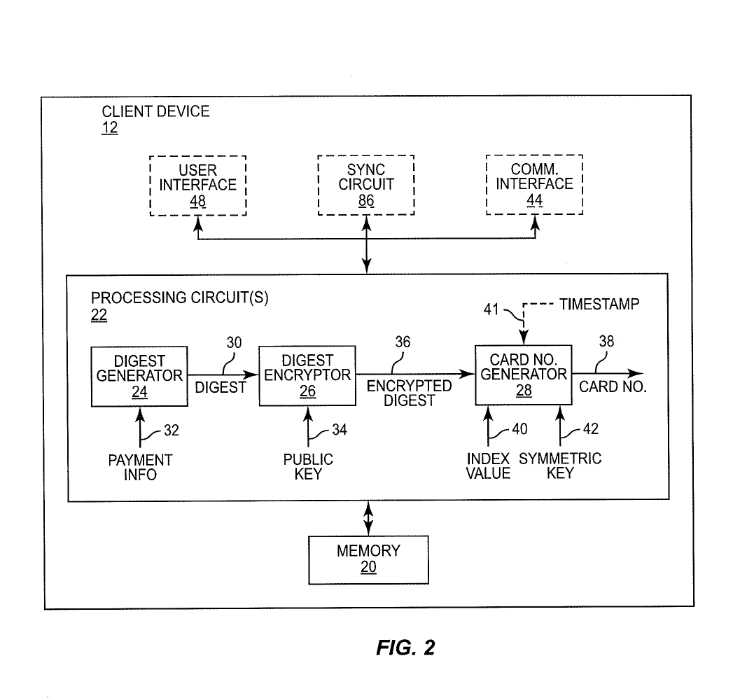

FIG. 2 illustrates processing details of the client device 12 for securing the payment information within the card number. As shown in FIG. 2, the client device 12 includes a memory 20 and one or more processing circuits 22. The memory 20 may include, at least in part, Electrically Erasable Programmable Read-Only Memory (EEPROM). Regardless, the memory 20 is configured to store the electronic payment information, a public key of a public-private key pair uniquely issued to the consumer, a symmetric key shared with the authorization server 16, and an index value. As explained below, this stored index value maps at the authorization server 16 to the payment information and to the private key of the public-private key pair.

The one or more processing circuits 22 include a digest generator 24, a digest encryptor 26, and a card number generator 28. The digest generator 24 is configured to generate a unique message digest 30 by applying a cryptographic hash function to the payment information 32 stored in memory 20 (or where the payment information 32 comprises multiple fields, to a concatenation of the payment information fields). The digest encryptor 26 is configured to then encrypt this generated digest 30 using the public key 34 stored in memory 20, to thereby obtain an encrypted digest 36. Finally, the card number generator 28 is configured to generate the card number 38 by encrypting the encrypted digest 36 and the stored index value 40 using the stored symmetric key 42 (e.g., where the encrypted digest 36 and index value 40 may be appended together for encryption).

In some embodiments, the client device 12 itself sends the generated card number 38 to the merchant system 14. For example, the client device 12 may include a communications interface 44 that permits a local card reader 46 in the merchant system 14 (see FIG. 1) to read the card number. In other embodiments, the client device 12 may include a user interface 48 that simply displays the generated card number 38 to the consumer, e.g., via a Light Emitting Diode (LED) or Liquid Crystal Display (LCD) output. This way, the consumer himself or herself can conduct the financial transaction remotely from the merchant. The consumer simply enters the displayed card number 38 into a remote terminal 50 (see FIG. 1, e.g., a home computer) that then sends the number to the merchant system 14 via the packet data network 18. In either case, the merchant system 14 then sends the card number 38 to the authorization server 16 via the packet data network 18.

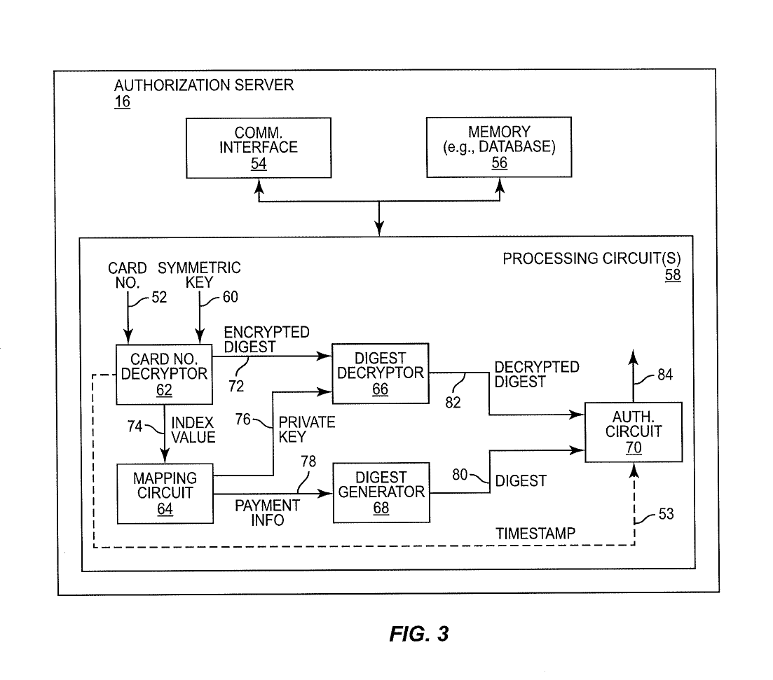

FIG. 3 illustrates processing details of the authorization server 16 for authorizing a financial transaction based on a received card number 52. The authorization server 16 includes a communications interface 54, an internal or external memory 56 (e.g., a database) and one or more processing circuits 58. The communications interface 54 is configured to receive a card number 52 via the packet data network 18. The memory 56 is configured to store a symmetric key 60. The memory 56 is also configured to store the private keys and payment information for a plurality of consumers, wherein different index values map to different private keys and payment information for different consumers.

The one or more processing circuits 58 include a card number decryptor 62, a mapping circuit 64, a digest decryptor 66, a digest generator 68, and an authorization circuit 70. The card number decryptor 62 is configured to decrypt the received card number 52 using the stored symmetric key 60 to obtain an encrypted digest 72 and an index value 74. The mapping circuit 64 is configured to then map the index value 74 to a private key 76 and to payment information 78 stored in memory 56 for a particular consumer.

The digest generator 68 next generates a unique message digest 80 by applying a cryptographic hash function (the same one as that applied by the client device 12) to the payment information 78 that was mapped to the index value 74. Meanwhile, the digest decryptor 66 decrypts the encrypted digest 72 using the private key 76 that was mapped to the index value 74, to obtain a decrypted digest 82. Finally, the authorization circuit 70 is configured to authorize the financial transaction if the unique message digest 80 generated by the digest generator 68 matches the decrypted digest 82. If the financial transaction is authorized, the authorization circuit 70 may for instance send an approval code 84 to the merchant system 14 over the packet data network 18, via the communications interface 54.

Note that the above authorization process in FIGS. 2 and 3 secures the consumer's payment information 32, 78 generally within the transmitted card number 38, 52 or more particularly within the unique message digest 30, 80. Thus, if the lower-layer security measures (e.g., SSL) are breached, only the card number 38, 52 is revealed, not the consumer's payment information 32, 78. And even if the multiple security layers introduced herein are breached (e.g., the asymmetric and symmetric encryption), the consumer's payment information 32, 78 is still not revealed.

For example, if the symmetric key 60 employed herein is compromised and used by a hacker to decrypt the card number 52, only an index value 74 and an encrypted digest 72 would be revealed to the hacker. The index value 74 in and of itself would remain meaningless to the hacker, as it simply points to a consumer's payment information 78 in the server's memory 56; it does not indicate the payment information 78 itself. Even further, if the private key 76 of the consumer's public-private key pair is compromised and used to decrypt the encrypted digest 72, the hacker would still only obtain the unique message digest 80, not the consumer's payment information 78. Indeed, the consumer's payment information 78 is irreversibly embodied within the digest 80.

In this regard, the cryptographic hash function used to irreversibly embody a consumer's payment information 78 in a digest 80 may comprise, for instance, a Secure Hash Algorithm (SHA) such as SHA-1 or SHA-256, a Message-Digest Algorithm such as MD5, a RACE Integrity Primitives Evaluation Message Digest (RIPEMD) such as RIPEMD-160, or the like. Any of these hash functions take a message as input and return a fixed-size hash value. It is infeasible to reverse this process and determine the input message from the hash value.

With regard to encryption and decryption of the digest using a consumer's public-private key pair, any of a number of asymmetric cryptography algorithms may be used. In such asymmetric algorithms, the key used to encrypt a message (the public key) is not the same as the key used to decrypt it (the private key). It is infeasible to derive the private key from the public key. These asymmetric algorithms include, for instance, RSA (Rivest, Shamir, and Adleman), DSA (Digital Signature Algorithm), and ECDSA (Elliptic Curve DSA).

Finally with regard to encryption and decryption of the encrypted digest and index value, any of a number of symmetric cryptography algorithms may be used. In such symmetric algorithms, the key used to encrypt a message is either the same as or is trivially related to the key used to decrypt the message. The keys thus in practice represent a shared secret between the client device and the authorization server. Examples of such algorithms include MAC-DES (Message Authentication Code—Data Encryption Standard) and AES (Advanced Encryption Standard).

Consider an embodiment using a DES symmetric algorithm specifically referred to in JavaCard as the “ALG_DES_MAC4_NOPAD” algorithm. Either DES is used in Cipher Block Chaining (CBC) mode of operation, or triple DES is used in outer CBC mode. The input to this algorithm must be (8 byte) block aligned.

Regardless, the card number generator 28 of the client device 12 uses this DES algorithm to encrypt the encrypted digest 36 and the index value 40, which results in a so-called encrypted block. The card number generator 28 then processes this result to obtain the card number 38.

As a practical example, presume the card number generator's encryption produces a 4-byte encrypted block represented by −24, −109, −31, 9, where each byte has a value within the range of −127 to 128. According to at least some embodiments, the card number generator 28 processes this encrypted block in two stages. During the first stage, the card number generator 28 prepends one or more predetermined first numbers (e.g., one or more zeros) to each byte of the encrypted block that has a value represented with less than 3 digits (excluding any negative sign). In doing so, the card number generator 28 converts each byte into a 3 digit representation using a predetermined process. Hence, after the card number generator 28 processes the example encrypted block, the block will be represented by −024, −109, −031, 009 (assuming the first predetermined number is “0”).

During the second stage, the card number generator 28 prepends one more number to each byte of the encrypted block, to convert each byte into a 4 digit representation. The particular number prepended to any given byte depends on the sign of that byte. In one embodiment, for example, the card number generator 28 prepends a second number (e.g., “9”) to a byte if the sign of that byte is negative, and prepends a third number (e.g., “8”) to a byte if the sign of that byte is positive. Thus, after the card number generator 28 processes the example encrypted block, the block will be represented by 9024-9101-9031-8009. The card number generator 28 employs this as the obtained card number 38.

The authorization server 16 applies the reverse process to obtain the encrypted block from the received card number 52.

In other embodiments, by contrast, the card number generator 28 processes the encrypted block in a single stage. Using the same example as above, for instance, the card number generator 28 converts the multi-byte encrypted block into a number that has a long data type. As one example, a long data type is a 64-bit signed two's complement integer, having a range between 2⁶³−1 and −2⁶³. Converting the encrypted block into a long number in this way advantageously generates a random, fixed-value number.

Converting the multi-byte encrypted block into a long number, in at least some embodiments, entails a number of operations. The pseudo-code below provides one example:

encryptedBlock[ ] = [byte1,byte2,...byteN];
longNum = 0;
for (i=0; i++; i=N) {
longNum = (longNum << 8) + (encryptedBlock[i] & 0xff)
}

As shown above, the multi-byte encrypted block is represented by an array encryptedBlock of N bytes, with different bytes in the array indexed by the variable i. Also, the long number is represented by the variable longNum, which is initialized to 0. After this initialization, the conversion of the encrypted block encryptedBlock into a long number longNum is implemented using a for loop as an iterative process that steps through the different bytes of the encrypted block encryptedBlock. Each iteration of the process determines a current value for the long number longNum by digitally multiplying a current byte i of the encrypted block encryptedBlock with 0×ff, and then adding the result to the previous iteration's longNum shifted left 8 times. The conclusion of the iterative process produces the converted long number longNum.

As one practical example, an encrypted block encryptedBlock that is equal to [−49, −67, 9, −12, −51, −59, −104, −50] would be converted by the above pseudo-code into a 19 digit long number longNum equal to −3477612390231205682. Ignoring the sign of the long number longNum, the card number generator 28 employs 16 digits as one part of the credit card number (e.g., as the part traditionally displayed on a physical credit card's front face) and employs the remaining 3 digits as another part of the credit card number (e.g., as the card security code). The authorization server 16 applies the reverse process to obtain the encrypted block from the received card number 52.

Given the various hash, asymmetric, and symmetric algorithm options and parameters, some embodiments herein provide even greater security through dynamic algorithm and/or parameter updates. The client device 12 in these embodiments further includes a synchronization circuit 86 configured to dynamically receive updates from the authorization server 16 regarding which particular hash function or encryption algorithm it is to employ, and/or which particular algorithm parameters it is to employ. Such updates may be received occasionally or periodically at the request of the client device 12, or in an unsolicited manner. The updates may further specify the particular encryption keys (e.g., the public or symmetric key) that the client device 12 is to use.

In some embodiments, the synchronization circuit 86 includes its own memory for storing an indication of the hash function or encryption algorithms (including the associated keys) to be employed according to the received updates. In this case, the processing circuit(s) 22 described above retrieve such values from the synchronization circuit's memory rather than the client device's general memory 20. In other embodiments, though, the synchronization circuit 86 simply coordinates storage of such indications in the general memory 20.

Still other embodiments tie one or more of the above encryption processes to the current time for additional security. In particular, the asymmetric encryption process used by the client device 12 to encrypt the unique message digest 30 proves quite secure in and of itself. Indeed, encrypting different digests with different public keys only very rarely produces the same encrypted digest (e.g., using RSA). To nonetheless guarantee that the value symmetrically encrypted will never be the same, these embodiments further append a timestamp 41 to the encrypted digest 36 and the index value 40 (See FIG. 2). This way, even in the rare instance that the encrypted digest 36 is a duplicate, the value symmetrically encrypted will still be different. The result is that the client device 12 generates a unique card number 38, specific to the current time and consumer using the client device 12.

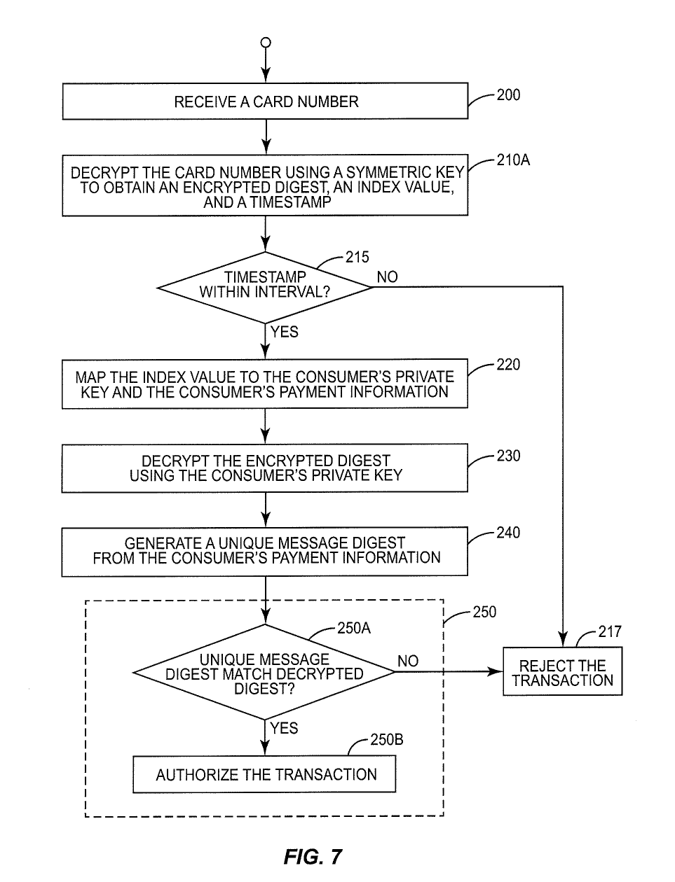

Thus, in this regard, the timestamp 41 imposes a durational limit on the validity of the card number 38 ultimately generated. Indeed, the authorization server's card number decryptor 62 obtains a timestamp 53 upon decrypting the received card number 38 (See FIGS. 3 and 7). If the timestamp 53 indicates the financial transaction has occurred within a predetermined time interval (e.g., within the last 100 seconds), the authorization server 16 proceeds with the authorization process described above. Otherwise, the authorization server 16 rejects authorization of the transaction. Thus, if lower-layer security measures are breached and the card number revealed, not only will the customer's payment information remain secure, but also the card number will become invalid after a predetermined time interval. Such greatly increases the security of financial transactions and deters card number theft.

Irrespective of the encryption approaches above, the digest 30 of the consumer's payment information 32 remains static; indeed, such is an inherent property of a hash function algorithm. Accordingly, while the above embodiments have described the client device 12 as dynamically generating the digest 30 from the consumer's payment information 32, those skilled in the art will also appreciate that the client device 12 may obtain the digest 30 in other ways. The client device 12 may, for instance, obtain a digest 30 from the consumer's payment information 32 by retrieving a previously generated and stored digest.

As yet another security measure, the client device 12 in some embodiments further includes an activation circuit (not shown). The activation circuit is configured to selectively activate the client device 12 based on user input received from the user interface 48. The user input may be, for example, a passcode such as a PIN, a fingerprint, a voice match, or the like received from the consumer via the user interface 48. If the user input received from the user interface 48 matches an expected response stored in memory 20, the activation circuit activates the client device 12 for operation as described above. Otherwise, the activation circuit rejects activation of the client device 12 and effectively prevents the client device 12 from conducting a financial transaction.

Note that the activation circuit in some embodiments may selectively activate different financial accounts associated with the client device 12 responsive to receiving different user input. In this way the consumer may conduct financial transactions with different financial accounts simply by entering different input (e.g., different PINs).

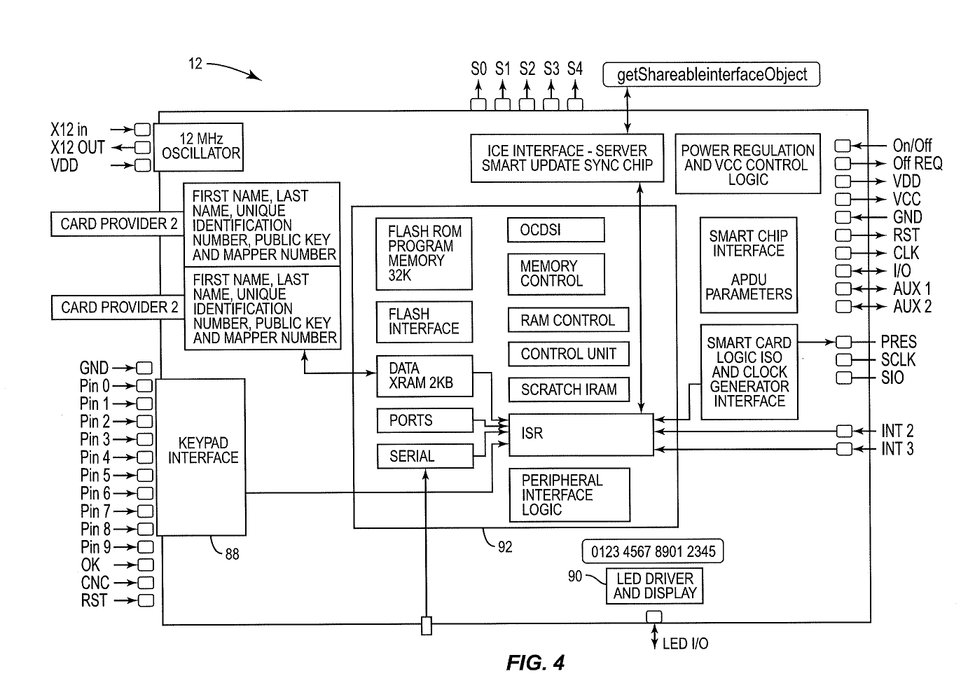

FIG. 4 illustrates an example of such a client device, where the client device is implemented using JavaCard technology. In FIG. 4, the user input comprises the keypad interface 88 for receiving different PINs from a user, as well as the LED Driver and Display 90 for displaying the generated card number 38. The one or more processing circuits 22 and memory 20 include the centermost collection of blocks 92, e.g., the control unit peripheral interface logic, and the like.

While the client device 12 has been described above as a standalone smart card, those skilled in the art will appreciate that the client device 12 may actually be integrated into a larger system, such as a computer, smart phone, or other terminal.

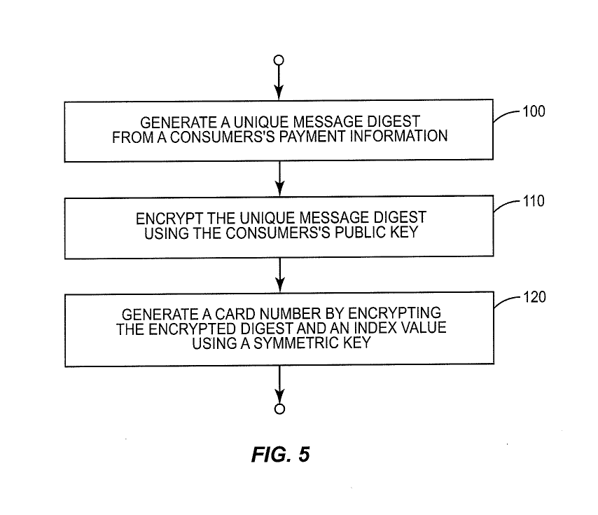

In view of the above variations and modifications described above, those skilled in the art will appreciate that the client device 12 generally performs the processing illustrated in FIG. 5 for securely conducting a financial transaction. As shown in FIG. 5, processing includes generating a unique message digest 30 by applying a cryptographic hash function to payment information 32 uniquely associated with the consumer (Block 100). Processing further includes encrypting the unique message digest 30 using a public key 34 of a public-private key pair uniquely issued to the consumer, to obtain an encrypted digest 36 (Block 110). Finally, processing includes encrypting the encrypted digest 36 and an index value 40 using a symmetric key 42, to generate a card number 38 to be sent to the authorization server 16 for authorization of the financial transaction (Block 120). Again, the index value 40 maps at the authorization server 16 to the private key 76 of the public-private key pair and to the consumer's payment information 32. In some embodiments, the processing further includes sending this card number 38 to the authorization server 16 via a packet data network 18.

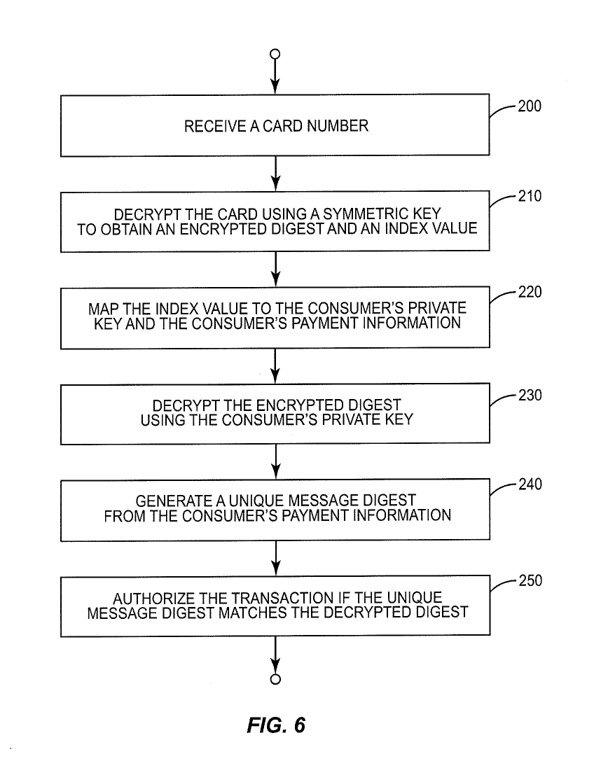

Those skilled in the art will also appreciate that the authorization server 16 generally performs the processing illustrated in FIG. 6 for securely authorizing a financial transaction. As shown in FIG. 6, processing includes receiving a card number 62 (Block 200) and decrypting that card number 62 using a symmetric key 60 to obtain an encrypted digest 72 and an index value 74 (Block 210). Processing then continues with mapping the index value 74 to a private key 76 of a public-private key pair uniquely issued to a consumer and to payment information 78 uniquely associated with that consumer (Block 220). Next, processing includes decrypting the encrypted digest 72 using the private key 76, to obtain a decrypted digest 82 (Block 230). Meanwhile, processing includes generating a unique message digest 80 by applying a cryptographic hash function to the payment information 78 (Block 240). Finally, processing ends with authorizing the financial transaction if the unique message digest 80 generated by the authorization server 16 matches the decrypted digest 82 (Block 250).

FIG. 7 illustrates variations to this encryption processing according to embodiments described above that tie the processing to the current time for additional security. As shown in FIG. 7, decrypting the card number 52 yields not only the encrypted digest 72 and index value 74, but also a timestamp associated with the time at which the card number 52 was generated (Block 210A). Processing then entails determining whether the timestamp indicates the card number 52 was generated within a predetermined time interval (Block 215). If not (NO at Block 215), then processing includes rejecting the financial transaction (Block 217). If so (YES at Block 215), processing proceeds as described above in FIG. 6, with Blocks 220, 230, 240, and 250. Note that FIG. 7 illustrates Block 250 in more detail, as including a determination as to whether the unique message digest 80 matches the decrypted digest 82 (Block 250A) and an authorization of the financial transaction (Block 250B) if there is a match (YES at Block 250A).

Although the present invention has been described herein with respect to particular features, aspects and embodiments thereof, it will be apparent that numerous variations, modifications, and other embodiments are possible within the broad scope of the present invention. Accordingly, all variations, modifications and embodiments are to be regarded as being within the scope of the invention. The present embodiments are therefore to be construed in all aspects as illustrative and not restrictive.

What is claimed is:

1. A method implemented by a client device used by a consumer to securely conduct a financial transaction, the method comprising:
generating a unique message digest by applying a cryptographic hash function to payment information uniquely associated with the consumer;
encrypting the unique message digest using a public key of a public-private key pair uniquely issued to the consumer, to obtain an encrypted digest; and
encrypting the encrypted digest and an index value using a symmetric key, to generate a card number to be sent to an authorization server for authorization of said financial transaction, wherein the index value maps at the authorization server to the private key of said public-private key pair and to said payment information.

2. The method of claim 1, further comprising sending the card number toward the authorization server using one or more cryptographic protocols that provide transport layer security.

3. The method of claim 1, wherein the payment information includes two or more payment information fields concatenated together, wherein the two or more payment information fields include two or more of:
a name of the consumer;
all or part of an identification number for the consumer; and
a financial account number of the consumer.

4. The method of claim 1, wherein encrypting the encrypted digest and the index value using the symmetric key, to generate the card number, comprises:
encrypting the encrypted digest and the index value using the symmetric key, to obtain an encrypted block having multiple bytes;
prepending one or more predetermined first numbers to each byte of the encrypted block that has a value represented with less than a predetermined number of digits, to obtain a modified encrypted block with each byte represented by the same number of digits; and
prepending either a predetermined second number or a predetermined third number to each byte of the modified encrypted block, depending on a sign of that byte, to obtain the card number.

5. The method of claim 1, wherein encrypting the encrypted digest and the index value using the symmetric key, to generate the card number, comprises:
encrypting the encrypted digest and the index value using the symmetric key, to obtain an encrypted block having multiple bytes; and
converting the encrypted block into a number having a long data type, to obtain said number as the card number.

6. The method of claim 1, wherein encrypting the encrypted digest and the index value using the symmetric key, to generate the card number, comprises encrypting the encrypted digest, the index value, and a timestamp associated with the time at which the card number is generated, using the symmetric key, to generate the card number.

7. A method implemented by an authorization server for secure authorization of a financial transaction, the method comprising:
receiving a card number;
decrypting the card number using a symmetric key to obtain an encrypted digest and an index value;
mapping the index value to a private key of a public-private key pair uniquely issued to a consumer and to payment information uniquely associated with that consumer;
decrypting the encrypted digest using said private key, to obtain a decrypted digest;
generating a unique message digest by applying a cryptographic hash function to said payment information; and
authorizing the financial transaction if the unique message digest generated by the authorization server matches the decrypted digest.

8. The method of claim 7, further comprising receiving the card number via one or more cryptographic protocols that provide transport layer security.

9. The method of claim 7, wherein the payment information includes two or more payment information fields concatenated together, wherein the two or more payment information fields include two or more of:
a name of the consumer;
all or part of an identification number for the consumer; and
a financial account number of the consumer.

10. The method of claim 7, wherein decrypting the card number using a symmetric key to obtain an encrypted digest and an index value comprises:
determining different bytes of an encrypted block from different sets of digits forming the card number, wherein determining a given byte of the encrypted block from a given set of digits forming the card number comprises identifying a sign of the byte based on recognizing whether a first or second predetermined number has been prepended to the set of digits and identifying a value of the byte based on recognizing any predetermined third numbers that have been prepended to the set of digits; and
decrypting the encrypted block using the symmetric key to obtain the encrypted digest and the index value.

11. The method of claim 1, wherein decrypting the card number using a symmetric key to obtain an encrypted digest and an index value comprises:
converting the card number from being a number having a long data type into an encrypted block of multiple bytes; and
decrypting the encrypted block using the symmetric key to obtain the encrypted digest and the index value.

12. The method of claim 7, wherein decrypting the card number using a symmetric key to obtain an encrypted digest and an index value comprises decrypting the card number to obtain the encrypted digest, an index value, and a timestamp associated with the time at which the card number was generated, wherein said authorizing comprises authorizing the financial transaction if the unique message digest generated by the authorization server matches the decrypted digest and the timestamp indicates the financial transaction has occurred within a predetermined time interval, and wherein the method further comprises rejecting the financial transaction if the timestamp indicates the financial transaction has not occurred within the predetermined time interval.

13. A client device used by a consumer to securely conduct a financial transaction, the client device comprising:
a digest generator configured to generate a unique message digest by applying a cryptographic hash function to payment information uniquely associated with the consumer;
a digest encryptor configured to encrypt the unique message digest using a public key of a public-private key pair uniquely issued to the consumer, to obtain an encrypted digest; and
a card number generator configured to encrypt the encrypted digest and an index value using a symmetric key, to generate a card number to be sent to an authorization server for authorization of said financial transaction, wherein the index value maps at the authorization server to the private key of said public-private key pair and to said payment information.

14. The client device of claim 13, further comprising a communication interface configured to send the card number toward the authorization server using one or more cryptographic protocols that provide transport layer security.

15. The client device of claim 13, wherein the payment information includes two or more payment information fields concatenated together, wherein the two or more payment information fields include two or more of:
a name of the consumer;
all or part of an identification number for the consumer; and
a financial account number of the consumer.

16. The client device of claim 13, wherein the card number generator is configured to encrypt the encrypted digest and the index value using the symmetric key, to generate the card number, by:
encrypting the encrypted digest and the index value using the symmetric key, to obtain an encrypted block having multiple bytes;
prepending one or more predetermined first numbers to each byte of the encrypted block that has a value represented with less than a predetermined number of digits, to obtain a modified encrypted block with each byte represented by the same number of digits; and
prepending either a predetermined second number or a predetermined third number to each byte of the modified encrypted block, depending on a sign of that byte, to obtain the card number.

17. The client device of claim 13, wherein the card number generator is configured to encrypt the encrypted digest and the index value using the symmetric key, to generate the card number, by:
encrypting the encrypted digest and the index value using the symmetric key, to obtain an encrypted block having multiple bytes; and
converting the encrypted block into a number having a long data type, to obtain said number as the card number.

18. The client device of claim 13, wherein the card number generator is configured to encrypt the encrypted digest and the index value using the symmetric key, to generate the card number, by encrypting the encrypted digest, the index value, and a timestamp associated with the time at which the card number is generated, using the symmetric key, to generate the card number.

19. An authorization server for secure authorization of a financial transaction, the authorization server comprising:
a communication interface configured to receive a card number;
a card number decryptor configured to decrypt the card number using a symmetric key to obtain an encrypted digest and an index value;
a mapping circuit configured to map the index value to a private key of a public-private key pair uniquely issued to a consumer and to payment information uniquely associated with that consumer;
a digest decryptor configured to decrypt the encrypted digest using said private key, to obtain a decrypted digest;
a digest generator configured to generate a unique message digest by applying a cryptographic hash function to said payment information; and
an authorization circuit configured to authorize the financial transaction if the unique message digest generated by the authorization server matches the decrypted digest.

20. The authorization server of claim 19, wherein the communication interface is configured to receive the card number via one or more cryptographic protocols that provide transport layer security.

21. The authorization server of claim 19, wherein the payment information includes two or more payment information fields concatenated together, wherein the two or more payment information fields include two or more of:
a name of the consumer;
all or part of an identification number for the consumer; and
a financial account number of the consumer.

22. The authorization server of claim 19, wherein the card number decryptor is configured to decrypt the card number using a symmetric key to obtain an encrypted digest and an index value by:
determining different bytes of an encrypted block from different sets of digits forming the card number, wherein determining a given byte of the encrypted block from a given set of digits forming the card number comprises identifying a sign of the byte based on recognizing whether a first or second predetermined number has been prepended to the set of digits and identifying a value of the byte based on recognizing any predetermined third numbers that have been prepended to the set of digits; and
decrypting the encrypted block using the symmetric key to obtain the encrypted digest and the index value.

23. The authorization server of claim 19, wherein the card number decryptor is configured to decrypt the card number using a symmetric key to obtain an encrypted digest and an index value by:
converting the card number from being a number having a long data type into an encrypted block of multiple bytes; and
decrypting the encrypted block using the symmetric key to obtain the encrypted digest and the index value.

24. The authorization server of claim 19, wherein the card number decryptor is configured to decrypt the card number to obtain the encrypted digest, an index value, and a timestamp associated with the time at which the card number was generated, and wherein the authorization circuit is configured to:
authorize the financial transaction if the unique message digest generated by the authorization server matches the decrypted digest and the timestamp indicates the financial transaction has occurred within a predetermined time interval; and
reject the financial transaction if the timestamp indicates the financial transaction has not occurred within the predetermined time interval.
